(19) United States
(12) Patent Application Publication
(10) Pub. No.: US 2010/0176675 A1
(43) Pub. Date: Jul. 15, 2010

(54) ELECTRIC ROTATING MACHINE, MAINLY FOR THE STARTER OF AN AUTOMOTIVE VEHICLE

(76) Inventors: Nicolas Labbe, Lyon (FR); Benoit Dupeux, Oyeu (FR); Jean-Paul Yonnet, Meylan (FR)

Correspondence Address: BERENATO & WHITE, LLC, 6550 ROCK SPRING DRIVE, SUITE 240, BETHESDA, MD, 20817, US

(21) Appl. No.: 12/687,706

(22) Filed: Jan. 14, 2010

(30) Foreign Application Priority Data
Jan. 15, 2009 (FR) FR09/50196

(51) Int. Cl. H02K 3/28; H02K 3/12; H02K 23/42

(52) U.S. Cl. 310/154.01; 310/195

(57) ABSTRACT

A DC electric rotating machine, mainly for the starter of an automotive vehicle. The machine includes a stator including a wound structure forming a plurality of poles extending along the circumference of the stator, a rotor, and a set of brushes adapted for the electric supply of the rotor by commutation of the electric current in sections of the rotor. The wound structure of the stator includes a plurality of slots between two central parts of consecutive poles of the stator, these slots being formed in a magnetic body of the stator. At least one of the slots including at least one conducting segment forming a winding of an electrical coil.

This application is a US Utility Patent Application, and claims priority to French Patent Application Number 09/50196 filed Jan. 15, 2009.

### FIELD OF INVENTION

The present invention relates especially to an electric rotating machine, mainly for the starter of an automotive vehicle.

### BACKGROUND OF THE INVENTION

As evident from FIG. 1, a starter including a stator 100 equipped with a plurality of magnetic poles 101 disposed on an internal circumferential surface of a yoke is known. Each magnetic pole 101 is formed by a metal polar core 102 around which an induction coil 104 is wound through which a DC current flows. This polar core 102 comprises a pole shoe 103 which extends it towards a rotor 108.

The problem with this starter is that to improve the driving magnetic torque, and consequently its output, it is necessary to wind more turns onto the induction coils and/or to increase the cross-section of the polar cores. This improvement in torque and output necessarily implies a starter of bulkier construction.

It has been found that a strong magnetic armature reaction in a DC electric machine with brushes, particularly a starter delivering magnetomotive force of great intensity at very low voltage and useful output of more than 1 kW, can cause a reduction in the performance of the machine. In some cases an angular shift of the brushes and/or a compensating or commutation assistance winding are used to mitigate the effects related to armature reaction. Angular deviation of the brushes is only optimum for a predetermined electric current and may degrade the useful torque delivered. Moreover the aforesaid winding is generally cumbersome.

### SUMMARY OF THE INVENTION

An aim of the invention is to propose an electric rotating machine which provides better useful torque per unit of volume, and consequently better useful power per unit of volume and better output. Thus performance can be improved with the same size of machine.

The object of the invention is a DC electric rotating machine, mainly for the starter of an automobile vehicle, the machine including:
a stator or inductor, having a wound structure forming a plurality of poles, extending along the circumference of the stator,
a rotor, or armature,
a set of brushes adapted for the electric supply of the rotor by commutation of the electric current in sections of the rotor, the machine being characterized in that the wound structure of the stator includes a plurality of especially substantially small slots, between two central parts of consecutive poles of said stator, these slots being formed in a magnetic body of the stator, and in that at least one of these slots includes at least one conducting segment forming an electrical coil and that the wound structure of the stator comprises at least one sector forming a pole, the slots being disposed on zones surrounding the central part of the pole.

The term “consecutive poles” is understood to mean two poles which follow one another circumferentially.

The invention as defined above in particular enables the wound structure to be created by distributing in the stator body the slots, substantially small and preferably equidistant between two central parts of circumferentially consecutive poles so as to produce a spatial distribution in the field system of the trapezoidal, even sinusoidal type, fixed in relation to the stator.

The slots can be non-equidistant between two central parts of circumferentially consecutive poles.

The applicant has found that such a wound structure can enable the driving magnetic torque to be increased, which, in the presence of heavy mechanical losses due to the action of the brushes on a commutator of the machine, allows the torque per unit of volume and equally the useful power and thus the output of the machine to be increased.

Moreover, this wound structure can enable harmonics in the waveform of the induction in an air-gap between the stator and the rotor to be cancelled, therefore any iron losses and consequently a drag magnetic torque, to be reduced, which equally allows the useful torque per unit of volume and thus the output of the machine to be increased.

Preferably, the wound structure can comprise at least one sector forming a pole, the slots able to be disposed on zones surrounding the central part of the pole, and these zones able to form almost two thirds of the circumferential length of this sector.

In other words the slots can be disposed substantially over two thirds of the circumferential length this sector.

Thus, the third harmonics in the waveform of the induction in an air-gap between the stator and the rotor are cancelled and any iron losses reduced.

Preferably also, all the slots on this sector can comprise at least one conducting segment forming a primary winding.

Preferably again, the stator can comprise four sectors each formed from at least six slots in every case. In other words, the machine comprises at least three pairs of slots per pole. In this case also, each first slotted zone can extend over an electrical angle of approximately 60°.

The electrical angle corresponds to an angle actually measured within the machine, also called mechanical angle, multiplied by the number of pairs of poles of the machine, which amounts to considering any machine as a juxtaposition within the same group of several elementary machines with only one pair of poles.

According to an exemplary embodiment of the invention, the wound structure of the stator comprises primary windings forming an electrical coil disposed in a concentric way on one pole of the stator, or of the “diamond” type centered on a pole.

In other words, the central part of the pole on either side of the latter can exhibit an identical number of ampere-turns (At) with absolute value.

Alternatively the wound structure of the stator, around the central part of a pole, particularly in slots of at least two sectors, can comprise windings allowing pre-distortion of the waveform of the induction in the air-gap in addition to the primary windings, all these windings forming an electrical coil of the “diamond” type, especially not centered on a central part of the pole.

In other words, the central part of the pole, on either side of the latter, can exhibit a different number of ampere-turns (At) with absolute value, so as to produce an effect which can be compared with a winding to compensate the magnetic armature reaction.

These electrical coils allowing pre-distortion, with no load that is to say when the machine is operating without load, can allow the waveform of the induction in the air-gap to distort in the opposite direction to the effect produced by the armature.

Consequently, when the machine is operating normally that is to say with load, the waveform of the induction in the air-gap as near as possible can approach a substantially trapezoidal, even sinusoidal shape.

This wound structure thus enables commutation of the machine to be improved and thus commutating losses to be reduced and wear of the brushes and interference by electric arcs to be limited.

The useful torque per unit of volume of the machine is therefore improved by a known effect to compensate the magnetic armature reaction in the presence of magnetic saturation, and consequently its output.

If desirable, the conducting segments can be made of several thin wires disposed in parallel so as to reduce Joule losses.

Preferably, this wound structure comprises equal coils around each central part of the pole.

According to another exemplary embodiment of the invention, the wound structure of the stator can comprise at least one sector including empty slots in the magnetic body of the stator to form at least one pole of the consecutive type.

Preferably, the wound structure of the stator can comprise these empty slots on at least 2 non-consecutive sectors.

Compared to massive consecutive poles, tipped or otherwise, such slotted consecutive poles allow the magnetic leakage fluxes to be minimized, by rendering part of the body of the magnetically permeable stator anisotropic.

Moreover, a saving in copper for the conducting segments can be achieved.

According to a particular feature, at least one compensating magnet is inserted in at least one empty slot. This magnet is polarized transversely, that is to say roughly axially relative to the radial direction of the machine.

According to another example, if desirable, at least one magnet to assist commutation can be arranged in place of the tooth straddling two consecutive sectors. This tooth can have a width greater than the adjacent teeth and cover an area equivalent to several adjacent teeth.

According to an exemplary embodiment of the invention, the wound structure comprises at least one sector, on one side of a pole, with at least one gap of magnetic material in the stator body between at least two slots.

This gap enables the pole to be rendered asymmetrical in order to reduce the magnetic armature reaction.

This wound structure can enable the shift of the magnetic neutral line whenever the armature flux increases to be reduced, even substantially cancelled and thus the effects of magnetic armature reaction to be virtually eliminated. The magnetic neutral line is defined as the point where the induction between two consecutive poles of the inductor is reduced to zero.

Preferably, this gap can be formed on an internal circumferential surface of the magnetic body of the stator, in particular between approximately ⅓ and approximately 1/10 of the circumferential length of the sector.

The gap can have a profile, seen along the longitudinal axis of the machine, with a general diagonal, concave or convex shape.

Alternatively, the gap can have the shape of a curve with at least one point of inflection.

Alternatively again, the gap can have the general shape of a U.

If desirable, the space left by the gap can be replaced by at least one non-magnetic positioning wedge to keep the electrical coils in place inside the slot.

Moreover, the gap can extend from an edge of the pole, in particular from its central part, level with its internal circumferential surface.

According to yet another exemplary embodiment of the invention, the wound structure of the stator can comprise at least one magnetic material gap in the stator body in an axis of the magnetic armature.

Preferably, the gap can be symmetrical in relation to a plane through which the axis of the machine passes.

The gap is always in the magnetic axis of the armature, whether the latter deviates angularly or otherwise.

If desirable, this gap can have a maximum volume in the axis of the armature.

According to an exemplary embodiment of the invention, the sector having slots including at least one conducting segment, on the central part of the pole, can comprise at least one slot formed in the magnetic body of the stator.

This slot can enable the effects of magnetic armature reaction in the event of magnetic saturation to be counteracted.

Moreover, this slot is preferably configured in the middle of the central part of the pole.

Moreover, the slot can have a depth greater than that of the slots of the sector.

If the sector comprises several slots, these can be distributed regularly in the middle of the central part of the pole.

If desirable, at least one magnet can be inserted in the central slot or the slot can be located in the zone most saturated due to armature reaction, so as to generate ampere-turns to compensate the magnetic armature reaction.

The height of this magnet for example can be equal to approximately half the depth of the stator body.

If desirable, the slot can be deeper than the magnet.

Alternatively, it is possible to use several magnets having a relatively low height, these magnets inserted or otherwise in slots deeper than the magnets.

According to another exemplary embodiment of the invention, the sector incorporating slots having at least one conducting segment, at one end, can comprise at least one slot comprising a winding generating ampere-turns of a sign opposed to the sign of the ampere-turns generated in a sector adjacent to this end.

The rotor comprises slots including windings generating ampere-turns and said end of the sector is determined as a function of the sign of the ampere-turns generated by the windings of the rotor, the sign of the ampere-turns generated by the slot located at said end of the sector needing to be opposed to the sign of the ampere-turns generated by the windings of the rotor disposed opposite the sector.

This structure enables auxiliary poles to be created between primary poles, so as to locally reduce induction due to the armature and thus to prevent too strong a parasitic electromotive force, degrading the output of the machine and accentuating the wear of the brushes, from being generated.

This enables commutation to be improved and therefore any commutating losses to be minimized.

Moreover, profiting from the presence of slots and therefore of teeth between said slots, it is possible to reduce the induction locally without inserting extra parts and thus without additional poles being formed.

According to yet another exemplary embodiment of the invention, the sector incorporating slots including at least one conducting segment comprises, at each end, at least one magnet to assist commutation.

This structure, by preventing too strong a parasitic electromotive force, degrading the output of the machine and accentuating the wear of the brushes, from being generated, allows commutation to be improved and therefore any commutating losses to be minimized.

If desirable, the same magnet can be used on two adjacent sectors.

In another exemplary embodiment of the invention, the slots of the stator can be closed on the internal circumferential surface of the magnetic body of the stator.

Preferably, the slots can be closed by magnetic wedges, thus enabling any iron losses to be minimized.

This structure, by exploiting the combined effect of the small thickness of the wedges and the magnetic saturation in these wedges, enables the harmonics of the waveform of the induction in the air-gap to be reduced, and a smoothing effect of the induction to be achieved.

Thanks to this smoothing, it may be possible to prevent a process of distortion of the slots of the stator.

If desirable, the rotor can comprise slots of the closed type.

In an exemplary embodiment of the invention, the stator and the rotor can comprise slots incorporating very thin insulation, particularly of the Kapton type.

With the same size of electric rotating machine, thanks to the Kapton® insulation in the slots, it is possible to reduce the thickness of these slots and therefore to enlarge the volume of the stator body and to increase its magnetic flux.

For example, the thickness of Kapton® insulation can vary between approximately 7.6 μm and approximately 19 μm instead of 0.1 mm for conductors with the smallest dimension of approximately 1 mm.

Moreover, Kapton® insulation is available as a film, having good mechanical and thermal resistance properties.

The electric rotating machine can be reversible.

The magnetic material of the stator body can be ferromagnetic.

The electric machine can comprise a reduction gear.

The invention, thanks to a gain in torque, enables the rotational speed of the commutator of the machine to be reduced for the same level of torque on starting, that is to say a torque lower than that corresponding to the maximum useful output, for a level of torque, which provides longer commutation time and consequently a reduction in losses and wear of the brushes and the commutator as the result of electric arcs (sparks).

Moreover, again thanks to the invention, due to a reduction in amplitude of the electric arcs, by improving commutation, it is possible to limit conducted and radiated electromagnetic interference, which is particularly advantageous as regards electromagnetic compatibility (EMC) of electrical and electronic equipment (on board a vehicle or otherwise) with the electric machine.

The electric machine according to the invention can be designed to operate with maximum useful power ranging between 500 W and 2000 W for example.

### BRIEF DESCRIPTION OF THE DRAWINGS

The invention can be understood better on reading the following detailed description of non-restrictive examples for implementing the invention, and on examining the appended drawing, wherein:

FIG. 1 illustrates, schematically and partially, in cross-section, a DC electric rotating machine according to the prior art of a starter for an automotive vehicle,

FIG. 2 illustrates, schematically and partially, the starter of an automotive vehicle in accordance with an exemplary embodiment of the invention,

FIG. 3a illustrates, schematically and partially, in cross-section, a DC electric rotating machine according to the invention,

FIG. 3b illustrates, schematically and partially, the arrangement of an electrical coil in the machine on FIG. 3a,

FIG. 3c illustrates an elaborated view of the winding of the stator,

FIG. 3d illustrates, schematically and partially, an example of the wound structure of the machine on FIG. 3a, with a magnet to assist commutation in accordance with an exemplary embodiment of the invention,

FIGS. 4a and 4b are two graphs illustrating a waveform of the induction along a circumference whose radius is roughly half the height of the teeth, according to the prior art and the invention respectively,

FIGS. 5a and 5b are two graphs illustrating the waveform of the induction in an air-gap of the machine on FIG. 3a as a function of the electrical angle, according to the prior art and the invention respectively,

FIGS. 6a and 6b illustrate, schematically and partially, an alternative arrangement of an electrical coil in the machine on FIG. 3a, with windings allowing pre-distortion of the waveform,

FIG. 6c illustrates an elaborated view of the winding of the stator,

FIGS. 7a and 7b illustrate, schematically and partially, two examples of the wound structure of the machine on FIG. 3a with consecutive poles, according to another exemplary embodiment of the invention,

FIGS. 8a, 8b, 8c, 8d and 8e illustrate, schematically and partially, five examples of the wound structure of the machine on FIG. 3a with gaps, according to an exemplary embodiment of the invention,

FIG. 9 is a graph illustrating the waveform of the induction in the air-gap as a function of the electrical angle, according to the exemplary embodiment of the invention on FIG. 6b,

FIGS. 10a, 10b and 10c illustrate, schematically and partially, three examples of the wound structure of the machine on FIG. 3a, with gaps,

FIGS. 11a, 11b and 11c illustrate, schematically and partially, three examples of the wound structure of the machine on FIG. 3a, with at least one slot, according to another exemplary embodiment of the invention,

FIGS. 12a and 12b illustrate, schematically and partially, two examples of the wound structure of the machine on FIG. 3a with auxiliary windings according to yet another exemplary embodiment of the invention,

FIG. 13 is a graph illustrating a waveform of the induction in the air-gap as a function of the electrical angle.

FIG. 14 illustrates, schematically and partially, an example of the wound structure of the machine on FIG. 3a with closed slots,

FIGS. 15a and 15b are two graphs illustrating the waveform of the induction in the air-gap as a function of the electrical angle, according to an exemplary embodiment of the invention of a wound structure with open and closed slots respectively,

FIG. 16 illustrates, schematically and partially, an electric rotating machine, according to another exemplary embodiment of the invention.

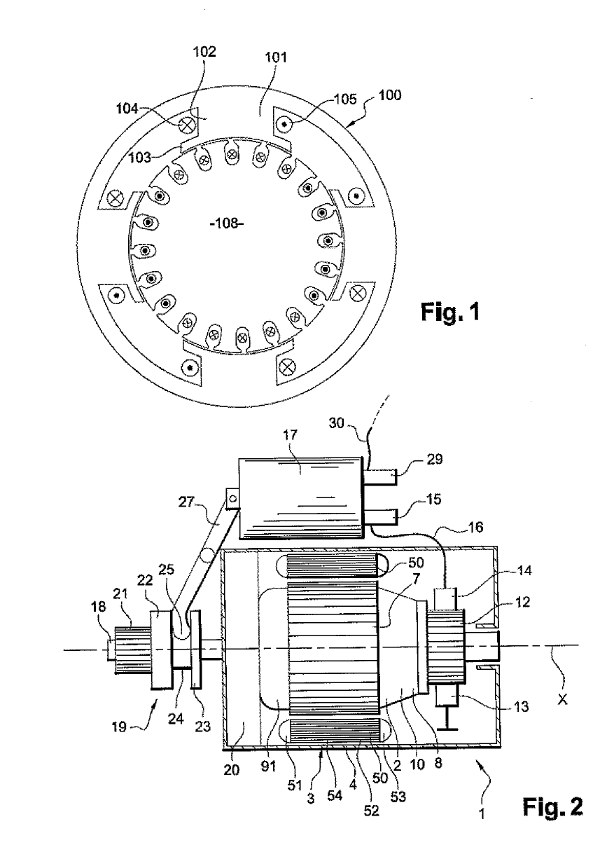

### DETAILED DESCRIPTION

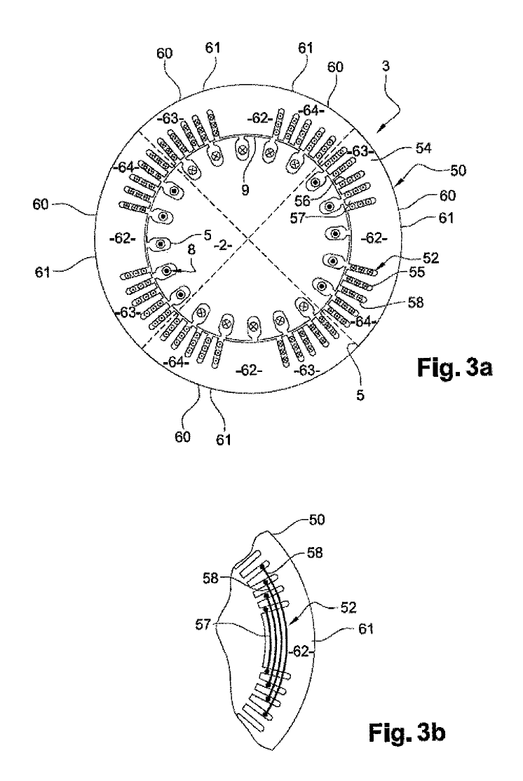

Illustrated very schematically on FIG. 2 is a starter 1 for an internal combustion engine of an automotive vehicle.

This DC starter 1 on the one hand comprises a rotor 2, also called armature, capable of rotating around an X axis, and on the other hand, a stator 3, also called inductor, around rotor 2.

This stator 3 comprises a yoke 4 carrying a wound structure 50 with excitation by electrical coils forming an inductive winding 52.

Inductive winding 52, on either side of a stator body 54, forms a front coil end 51 and a rear coil end 53.

Rotor 2 comprises a rotor body 7 and a winding 8 wound in slots of the rotor body 7.

Winding 8, on either side of rotor body 7, forms a front coil end 91 and a rear coil end 10.

Rotor 2, at the rear, is provided with a commutator 12 including a plurality of contactors electrically connected to the conducting elements, formed by wires in the example considered, of winding 8.

A set of brushes 13 and 14 is provided for the electric supply of winding 8, one of brushes 13 being connected to the earth of starter 1 and another of brushes 14 being connected to an electric terminal 15 of a contactor 17 via a wire 16. The brushes are four as an example.

Brushes 13 and 14 come to rub on commutator 12 when rotor 2 is in rotation, allowing the electric supply of rotor 2 by commutation of the electric current in sections of rotor 2.

Starter 1 also comprises a starter drive assembly 19 mounted in a sliding way on a drive shaft 18 and capable of being set in rotation around the X axis by rotor 2.

A reduction gear unit 20 is intermediate between rotor 2 and drive shaft 18, in a way known per se.

Alternatively, starter 1 can be of the “direct drive” type, without a reduction gear.

Starter drive assembly 19 comprises a drive element formed by a pulley 21 and designed to engage on a drive body of the internal combustion engine, not illustrated. This drive body is a belt for example.

Pulley 21 can be replaced by a gear element, in particular a toothed wheel, to turn the internal combustion engine.

Starter drive assembly 19 also comprises a free wheel 22 and a disc pulley 23 between them defining a groove 24 to receive end 25 of a fork 27.

This fork 27 is produced for example by moulding a plastic material.

Fork 27 is actuated by contactor 17 to move starter drive assembly 19 relative to drive shaft 18, along the X axis, between a first position, in which starter drive assembly 19 turns the internal combustion engine via pulley 21 and a second position, in which starter drive assembly 19 is disengaged from the internal combustion engine.

Contactor 17, in addition to terminal 15 connected to brush 14, comprises a terminal 29 connected via an electric connecting element, more particularly a wire 30, to an electric supply of the vehicle, notably a battery.

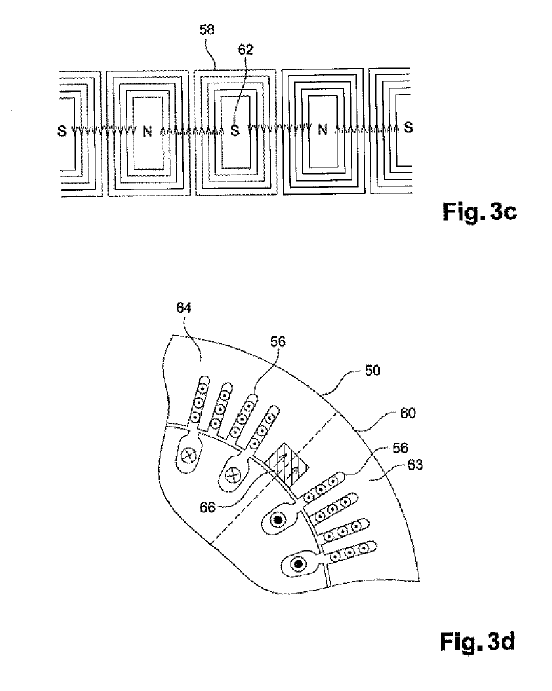

Illustrated on FIG. 3a is an example of wound structure 50 in accordance with a first exemplary embodiment of the invention.

This wound structure 50 extends along a circumference from stator 3 and comprises magnetic stator body 54.

Wound structure 50 comprises four sectors 60 separated by the dotted lines S on FIG. 3a and each forming a pole 61.

Each pole 61 comprises a central part 62 made from magnetic, for example ferromagnetic, material of stator body 54, and two zones 63 and 64 adjacent to central part 61, and surrounding it along the circumference of stator 3.

These zones 63 and 64 comprise slots 56 in which are inserted conducting segments 55 forming primary windings 58 of electrical coil 52, and teeth 57.

These zones 63 and 64 cover approximately two thirds of the circumferential length of sector 60.

Slots 56 are small in relation to the central part of pole 62, and are equidistant between two central parts 62 of consecutive poles 61.

Primary windings 58 are concentrically arranged on pole 61 so as to form electrical coil 52, as evident in a diagrammatic way on FIG. 3b and in an elaborated way on FIG. 3c.

Central part 62 of pole 61, on either side of the latter, exhibits an identical number of ampere-turns (At) with absolute value, near the sign.

As evident from FIG. 3b, wound structure 50, between two slots 56 located on zones 63 and 64 adjacent to two neighbouring sectors 60, comprises a radially polarized magnet 66 forming an auxiliary pole to assist commutation.

This structure 50, by preventing too strong a parasitic electromotive force, degrading the output of the machine and accentuating the wear of the brushes, from being generated, allows commutation to be improved and therefore any commutating losses to be minimized.

Also illustrated on FIG. 3a are slots 5 of rotor 2 as well as an air-gap 9 formed between the internal circumferential surface of stator 3 and the external circumferential surface of rotor 2.

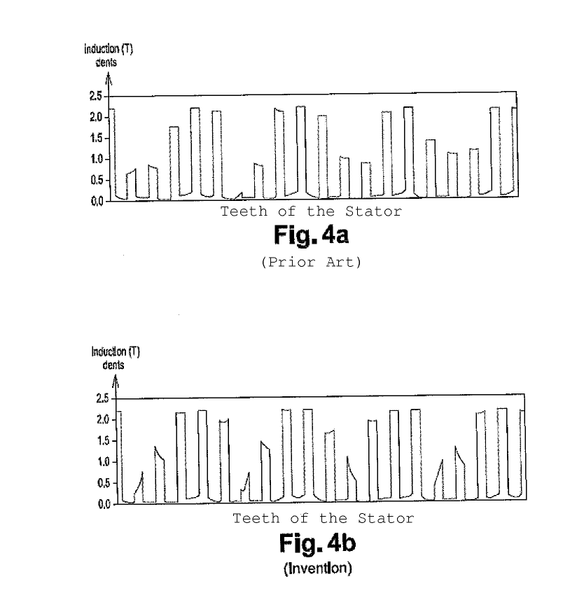

As evident from FIGS. 4a and 4b, which illustrate a waveform of the induction along a circumference whose radius is roughly half the height of teeth 57 of stator 3 according to the prior art and the invention respectively, induction is more uniform thanks to the invention, which shows that teeth 57 of stator 3 are better utilized.

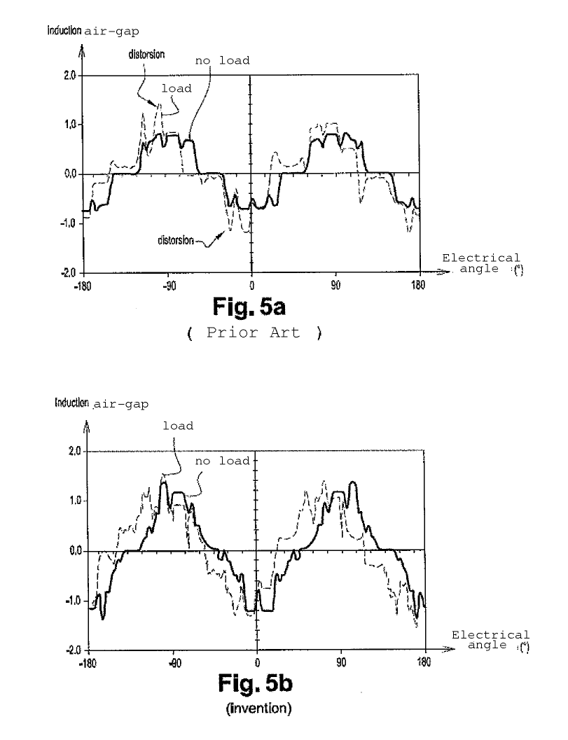

As evident from FIGS. 5a and 5b, which illustrate the waveform of the induction in air-gap 9 of the machine on FIG. 3a as a function of the electrical angle, according to the prior art and the invention respectively, distortion appears between the no load and load states in the machine of the prior art. Indeed, the crenel type profile with as consequence over-utilization and under-utilization of the magnetic material in the teeth is lost, whereas thanks to the invention, the distortion is greatly mitigated as illustrated on FIG. 5b.

As also evident from FIG. 5b, de-phasing is present between the no load and load states, in place of distortion, which is beneficial because there are no consequences on the harmonic content of the waveform.

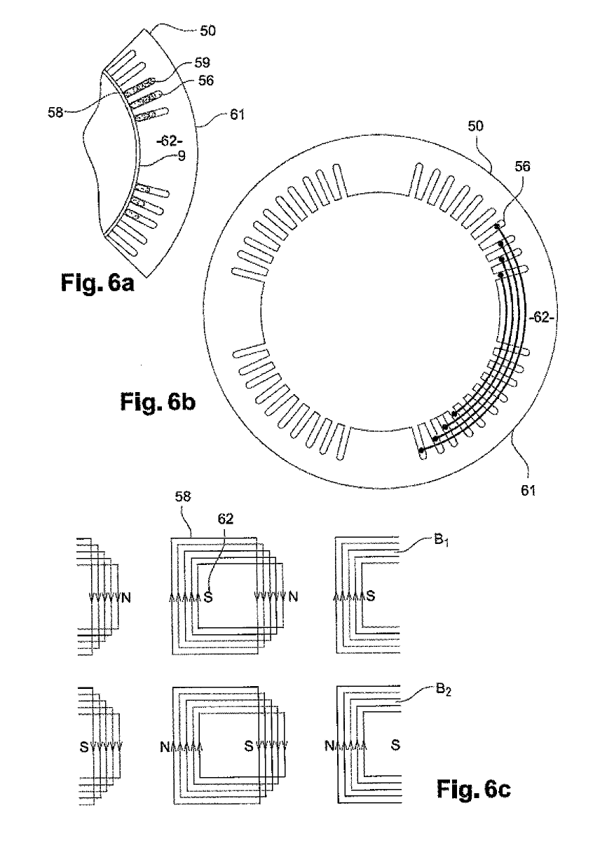

FIGS. 6a and 6b show a wound structure 50, around central part 62 of a pole 61, comprising windings 59 allowing pre-distortion of the waveform of the induction in air-gap 9 in addition to primary windings 58.

These windings 58 and 59 arranged in equal coils are superimposed in slots 56 to achieve imbalance in the different number of ampere-turns (At) with absolute value, on either side of central part 62 of pole 61. Two sets of coils (B1 and B2) with equal windings 58 are superimposed. To achieve imbalance in the different ampere-turns for the sets of coils B1 and B2, a different number of turns in series per slot can be used for example.

This enables an effect to be produced which can be compared with a winding to compensate the magnetic armature reaction, that is to say these windings 59 allow the waveform of the induction in the air-gap to be distorted in the opposite direction to that which the armature produces, so that this waveform is almost trapezoidal, even sinusoidal. These windings allowing pre-distortion 59 are provided on all poles 61 of machine 1.

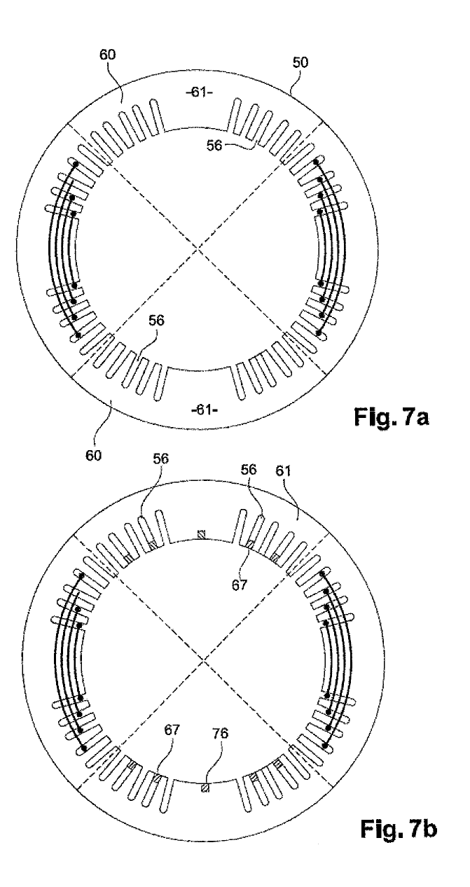

According to an exemplary embodiment of the invention illustrated on FIG. 7a, wound structure 50 comprises two non-consecutive sectors 60 including empty slots 56 to form at least pole 61, of the consecutive type.

Compared to massive consecutive poles, tipped or otherwise, such slotted consecutive poles enable the magnetic leakage fluxes to be minimized, by rendering part of the body 54 of the magnetically permeable stator anisotropic.

As evident from FIG. 7b, wound structure 50, in empty slots 56 located on a consecutive pole 61, comprises transversely polarized magnets 67 forming compensatory ampere-turns. Magnet 76 located in the middle of the consecutive pole is a compensating magnet. Several compensating magnets can be envisaged in said pole.

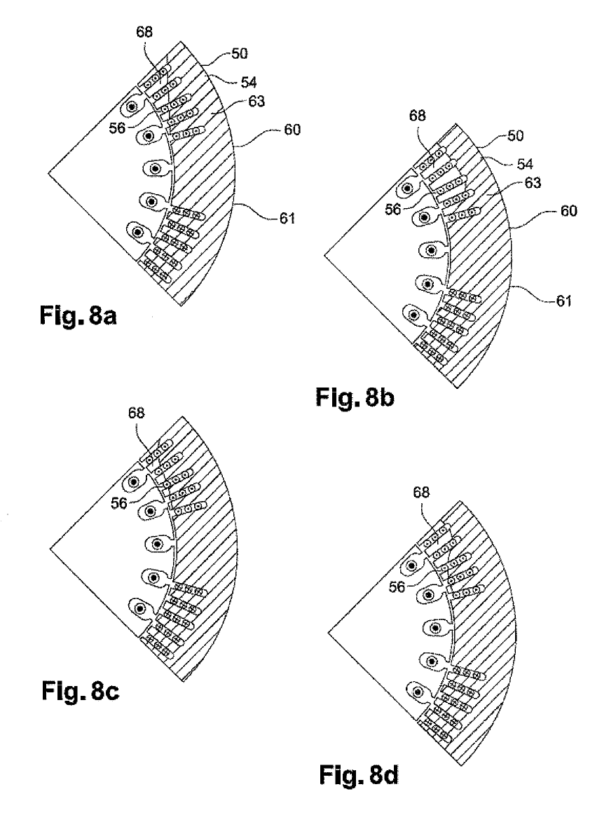

As illustrated on FIGS. 8a-8e, wound structure 50 comprises a sector 60, on one side of pole 61, that is to say on zone 63, including a gap 68 of magnetic material in stator body 54 between slots 56. Gap 68 does not continue in the adjacent sector 60. Gap 68 appears periodically on the circumference of a sector 60.

This gap 68 enables pole 61 to be rendered asymmetrical in order to reduce the effects of magnetic armature reaction, particularly angular shift of the neutral line.

Gap 68 is arranged along the internal circumferential surface of the magnetic body of stator 54 and extends from the edge of pole 61, level with this internal circumferential surface of stator body 54, towards the bottom of slots 56, over a length constituting a distance of approximately ⅓ to approximately 1/10 of the circumferential length of sector 60.

As evident from FIGS. 8a, 8b and 8c respectively, seen in the X axis, the gap has a profile with a general diagonal, concave or convex shape.

Gap 68 on FIG. 8d, seen in the X axis, has the shape of a curve incorporating a point of inflection.

Gap 68 on FIG. 8e, seen in the X axis, has the general shape of a U.

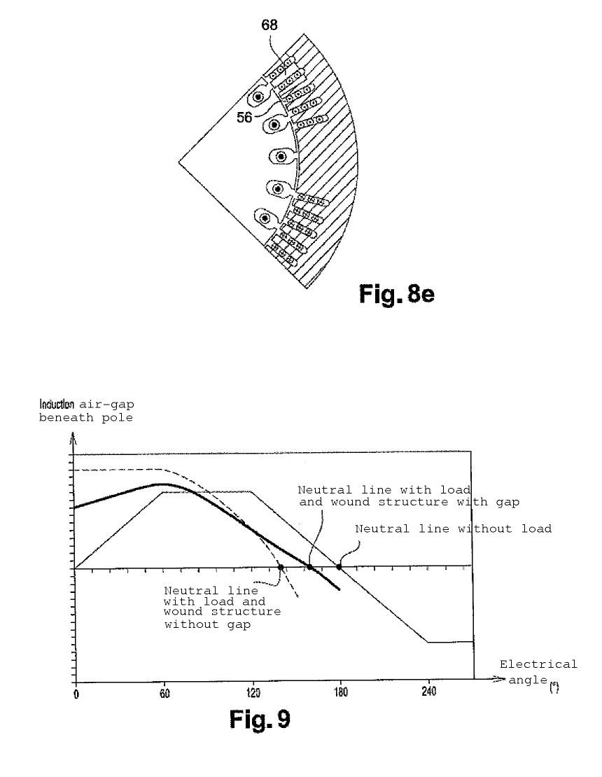

FIG. 9 illustrates the waveform of the induction in the air-gap 9 under a pole 61 as a function of the electrical angle, when wound structure 50 comprises a gap 68 as illustrated on FIG. 8e.

The angular shift of the neutral line of the machine when operating without load and with load enables the effect of the magnetic armature reaction to be quantified.

The removal of material, with load, enables the displacement, or angular shift, of the magnetic neutral line to be reduced whenever the armature flux increases, and therefore the effects of magnetic armature reaction to be substantially cancelled. The magnetic neutral line is defined as the point where induction between two consecutive poles 61 of the inductor is reduced to zero.

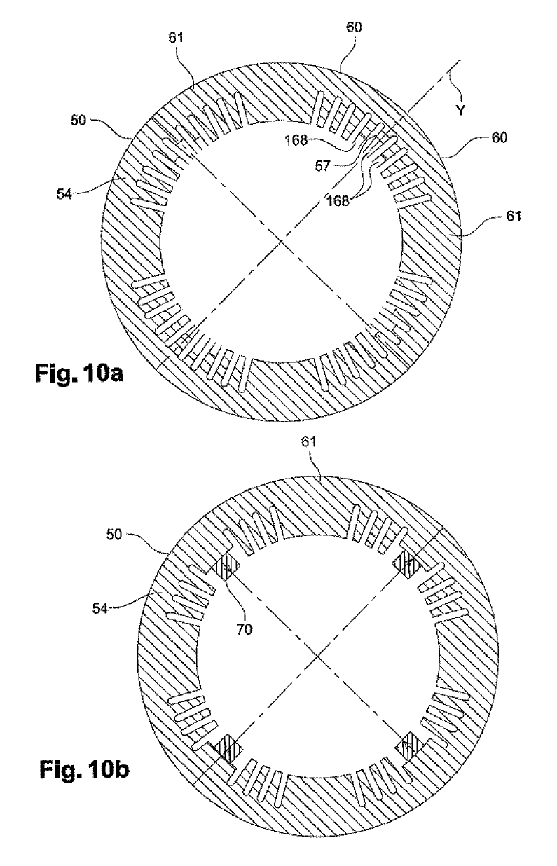

According to another embodiment of the invention, with reference to FIG. 10a, wound structure 50 comprises at least one magnetic material gap 168 in stator body 54 in the magnetic Y axis of the armature.

This gap 168 enables the magnetic permeance in the Y axis of the armature to be reduced in order to improve commutation by reducing armature inductance.

This structure 50, by preventing too strong a parasitic electromotive force, degrading the output of the machine and accentuating the wear of the brushes, from being generated, allows commutation to be improved and therefore any commutating losses to be minimized.

In the example illustrated on FIG. 10a, gap 168 is formed over a tooth and a half 57 on a sector 60 at both ends of each pole 61 of wound structure 50 and preferably is symmetrical relative to a plane through which the X axis of the machine passes.

Tooth 57, being inside the Y axis of the magnetic armature, exhibits a maximum volume for removal of ferromagnetic material.

In other words, teeth 57 have a different height depending on the removal of material.

As evident from FIG. 10b, gap 168 straddles two consecutive poles 61 and wound structure 50 comprises an auxiliary pole to assist commutation formed by a radially polarized permanent magnet 70, in the zone comprising gap 168 and at least two adjacent slots 52. The gap can only be partial, that is to say it cannot be as deep as a slot 52.

Magnet 70 straddles stator body 54, in other words no slot is formed under this magnet 70.

Magnet 70 is thus disposed on two adjacent sectors 60.

As evident from FIG. 10c, gap 168 is angularly offset in relation to the gap on FIG. 10a so as to follow the Y axis of the armature, in order to improve commutation.

In this case, gap 168 is formed over three teeth 57 of each pole 61 of wound structure 50 and is also symmetrical in relation to a plane through which the X axis of the machine passes.

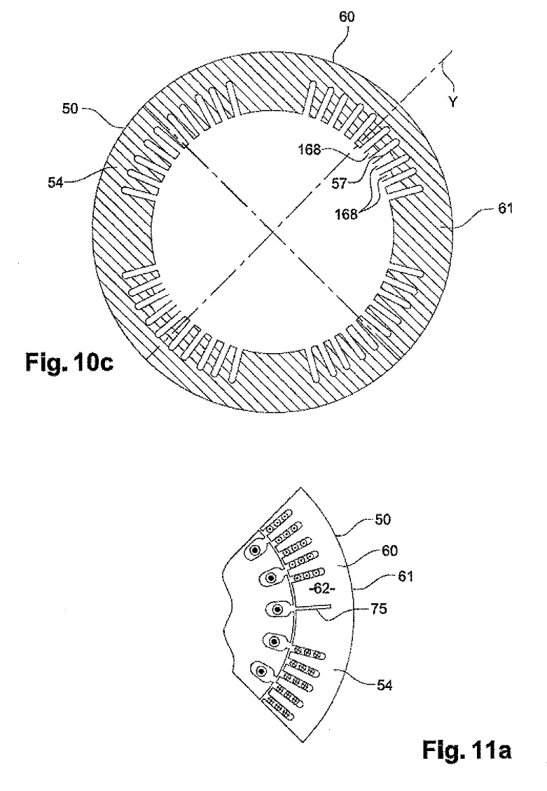

According to another embodiment of the invention, with reference to FIG. 11a, sector 60 on central part 62 of pole 61, comprises a slot 75 formed in the magnetic body of stator 54 and disposed in the middle of this central part 62.

This slot 75 enables the effects of magnetic armature reaction in the event of magnetic saturation to be counteracted.

If desirable, central part 62 of pole 61 can comprise several slots 75, three as an example.

As evident from FIG. 11b, a transversely polarized magnet 76 is inserted in slot 75 so as to combat the effects of saturation due to magnetic armature reaction.

Indeed, this magnet 76 generates ampere-turns to compensate the magnetic armature reaction.

In the example described on FIG. 11b, magnet 76 has a height equal to approximately half the depth of stator body 54, and is equal to the depth of slot 75.

If desirable, the slot can be deeper than the magnet.

The slot can be deeper than the slots.

As illustrated on FIG. 11c, wound structure 50 comprises three slots 75 on a central part of pole 62, each slot 75 being less deep than slots 56 of this pole 61, and a magnet 76 is inserted in each slot 75.

Each magnet 76 has a height not allowing the associated slot 75 to be completely filled.

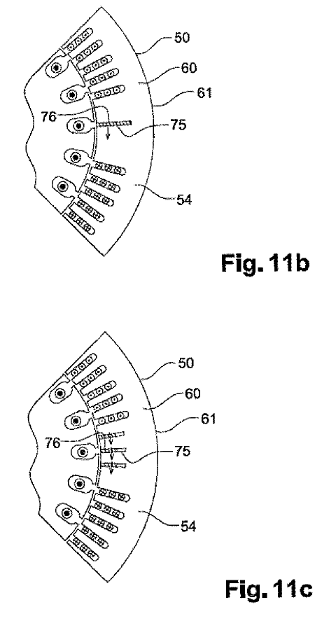

According to another exemplary embodiment of the invention illustrated on FIG. 12a, a sector 60, at one end 81, incorporates a slot 56 comprising a winding 80 generating ampere-turns of a sign opposed to the sign of the ampere-turns generated in a sector 60 adjacent to this end 81.

End 81 of sector 60 is selected according to the sign of the ampere-turns generated by electrical coil windings 8 of rotor 2.

Indeed, the sign of the ampere-turns generated by the winding 80 located at end 81 of sector 60 must be opposed to the sign of the ampere-turns generated by windings 8 of rotor 2 disposed opposite this sector 60.

This enables commutation to be improved and therefore any commutating losses to be minimized.

As evident from FIG. 12b, wound structure 50 between, on the one hand, slot 56 comprising winding 81 generating different ampere-turns and located at one end 80 of a sector 60, and, on the other hand, slot 56 of a sector 60 adjacent to this end 81, also includes a radially polarized magnet 77 forming an auxiliary pole to assist commutation.

This structure 50, by preventing too strong a parasitic electromotive force, degrading the output of the machine and accentuating the wear of the brushes, from being generated, allows commutation to be improved and therefore any commutating losses to be minimized.

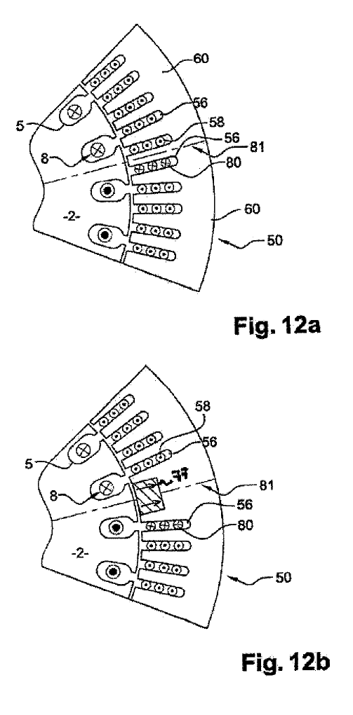

FIG. 13 is a graph which illustrates a waveform of the induction in air-gap 9 as a function of the electrical angle, whenever an improvement in commutation is sought.

It is evident from this graph that the magnetic flux density, depending on the wound structure selected, is greatly reduced during commutation.

Indeed, the wound structure comprising teeth of variable height enables the intensity of induction in the air-gap to be reduced during commutation in comparison to this same induction in the case of a wound structure with teeth of identical height.

Moreover, it is noted that a wound structure comprising at least one magnet to assist commutation again enables the intensity of induction in the air-gap to be reduced in the angular range wherein commutation takes place.

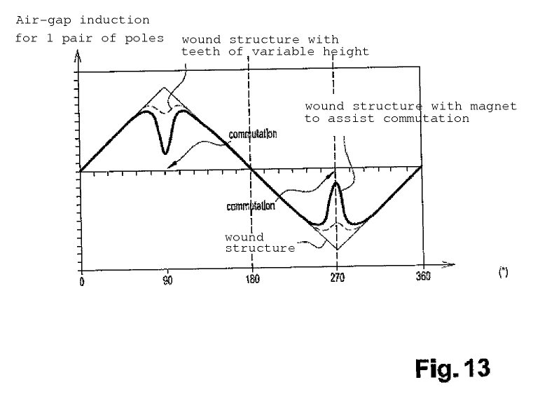

In another exemplary embodiment of the invention illustrated on FIG. 14, slots 56 of wound structure 50 are closed, thanks to magnetic wedges 90, bonded to the internal circumferential surface of the magnetic body of stator 54 for example.

This wound structure 50, on the one hand, enables any iron losses to be minimized, and in addition, an induction smoothing effect to be achieved by exploiting the combined effect of the small thickness of wedges 90 and the magnetic saturation in these wedges 90.

Thanks to this smoothing, it may be possible to prevent a process of distortion of the slots of the stator.

If desirable, rotor 2 can comprise slots 5 of the closed type.

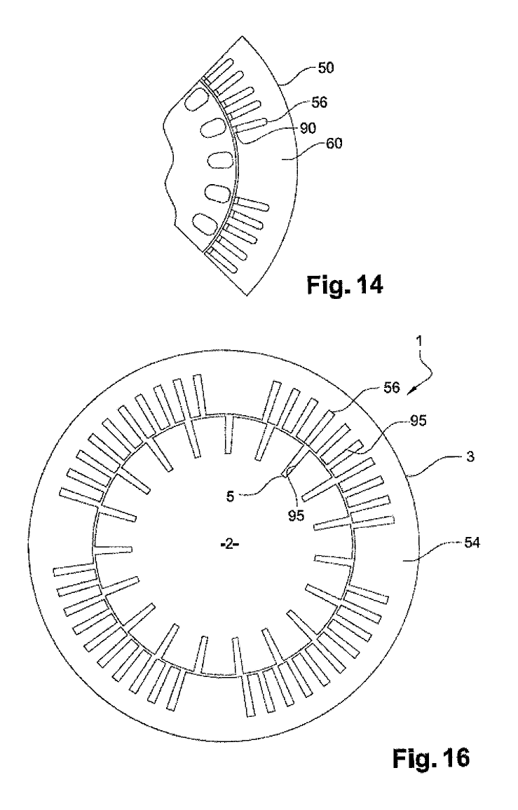

As evident from FIGS. 15a and 15b which illustrate the waveform of the induction in air-gap 9 as a function of the electrical angle, in the case of a wound structure 50 with opened and closed slots 56 respectively, the smoothing effect of this waveform when slots 56 are closed is clear

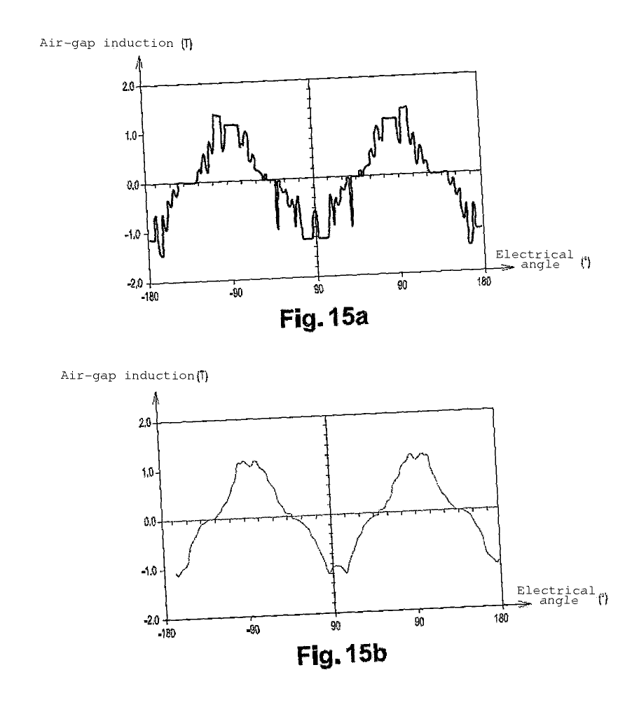

FIG. 16 illustrates an exemplary embodiment of the invention according to which stator 3 and rotor 2 comprise slots 56 and 5 having very thin insulation 95, of the Kapton® type.

The use of this extremely thin insulation 95, with the same size of starter 1, enables the thickness of slots 56 and 5 to be reduced and therefore the volume of stator body 54 to be enlarged.

For example, the thickness of Kapton® insulation 95 can vary between approximately 7.6 μm and approximately 19 μm.

The alternatives described can be used alone or in combination without leaving the scope of the invention.

1. A DC electric rotating machine, mainly for the starter of an automotive vehicle, the machine including:
a stator (3) having a wound structure (50) forming a plurality of poles, extending along the circumference of the stator (3),
a rotor (2),
a set of brushes (13, 14) adapted for the electric supply of the rotor (2) by commutation of the electric current in sections of the rotor (2), the machine (1) being characterized in that wound structure (50) of the stator (3) comprises a plurality of slots (56) between two central parts (62) of consecutive poles (61) of the stator (3), these slots (56) being formed in a magnetic body (54) of the stator (3), and in that at least one of these slots (56) includes at least one conducting segment (55) forming a winding (58) of an electrical coil (52), and in that wound structure (50) of the stator (3) comprises at least one sector (60) forming a pole (61), the slots (56) being disposed on zones (63, 64) surrounding the central part (62) of the pole (61).

2. A machine according to claim 1, characterized in that the zones (63, 64) constitute almost two thirds of the circumferential length of the sector (60).

3. A machine according to claim 1, characterized in that wound structure (50) of the stator (3) comprises primary windings (58) forming an electrical coil (52) concentrically arranged on a pole (61) of the stator (3).

4. A machine according to claim 1, characterized in that wound structure (50) of the stator (3), around the central part (62) of a pole (61), comprises primary windings (58) and windings (59) allowing pre-distortion of a waveform of the induction in an air-gap (9) between the rotor (2) and the stator (3), all these windings (58, 59) forming an electrical coil of the “diamond” type.

5. A machine according to claim 1, characterized in that the wound structure (50) of the stator (3) comprises at least one sector (60) including empty slots (56) in the magnetic body (54) of the stator (3) to form at least one pole (61) of the consecutive type.

6. A machine according to claim 5, characterized in that at least one compensating magnet (67) is inserted in at least one empty slot (56).

7. A machine according claim 1, characterized in that wound structure (50) comprises at least one sector (60) incorporating, on one side of a central part (62) of the pole (61), at least one gap (68) of magnetic material in the stator body (54) between at least two slots (56).

8. A machine according to claim 1, characterized in that wound structure (50) of the stator (3) comprises at least one gap (168) of magnetic material in the stator body (54) in a magnetic axis (Y) of the stator.

9. A machine according to claim 1, characterized in that the sector (60) incorporating slots (56) including at least one conducting segment (55) on a central part (62) of a pole (61), comprises at least one slot (75) formed in the magnetic body (54) of the stator.

10. A machine according to claim 9, characterized in that at least one magnet (76) is inserted in a slot (75).

11. A machine according to claim 1, characterized in that the sector (60) incorporating slots (56) including at least one conducting segment (55), at one end, (81) comprises at least one slot (56) including a winding (80) generating ampere-turns of a sign opposed to the sign of the ampere-turns generated by windings (58) in a sector (60) adjacent to this end (81).

12. A machine according to claim 11, wherein the rotor (2) comprises slots (5) including windings (8) generating ampere-turns, characterized in that the end (81) of the sector (60) is determined according to the sign of the ampere-turns generated by windings of the rotor (2), the sign of the ampere-turns generated by the slot (56) located at the end (81) of the sector (60) needing to be opposed to the sign of the ampere-turns generated by windings (8) of the rotor (2) disposed opposite this sector (60).

13. A machine according to claim 1, characterized in that the sector (60) incorporating the slots (56) including at least one conducting segment (55), at each end (81), comprises at least one magnet to assist commutation (66, 70, 77).

14. A machine according to claim 1, characterized in that the slots (56) of the stator (3) are closed on the internal circumferential surface of the magnetic body (54) of the stator (3), particularly by magnetic wedges (90).

15. A machine according to claim 1, characterized in that the stator (3) and the rotor (2) comprise slots (56, 5) including a very thin insulation (95), especially of the Kapton® type.

16. A starter (1) of an automotive vehicle including an electric rotating machine according to claim 1.
